(19) United States
(12) Patent Application Publication
(10) Pub. No.: US 2003/0048983 A1
(43) Pub. Date: Mar. 13, 2003

(54) Fiber optic switching system

(75) Inventor: Oleg Abel, Arad (IL)

Correspondence Address: FITCH EVEN TABIN AND FLANNERY, 120 SOUTH LA SALLE STREET, SUITE 1600, CHICAGO, IL, 60603-3406, US

(73) Assignee: Fiber Switch Technologies, Ltd.

(21) Appl. No.: 09/952,023

(22) Filed: Sep. 13, 2001

(51) Int. Cl. G02B 6/35

(52) U.S. Cl. 385/22; 385/18

(57) ABSTRACT

An optic switching system and method are presented for controllably directing an incident beam of electromagnetic radiation propagating with a certain solid angle from a primary optical waveguide to a predetermined secondary optical waveguide. A primary reflective concave surface is disposed for receiving the incident beam, reflecting the incident beam and focusing a reflected beam at a primary focusing place. A secondary reflective concave surface having a radius less than a radius of the primary reflective concave surface is disposed for receiving the beam reflected by the primary reflective surface and reflecting this beam to the predetermined secondary optical waveguide. The secondary reflective concave surface is disposed at the place located downstream of the primary focusing place with respect to the direction of propagation of the beam reflected from the primary reflective concave surface. An actuator is operatively connected to one of the reflective surfaces or to both and is adapted for controlling a selective displacement of the respective reflective surface relative to the optical beam that impinges thereon.

### FIELD OF THE INVENTION

This invention is generally in the field of optical communications, and relates to an optical light directing method and system for use in fiber optic switching systems.

### BACKGROUND OF THE INVENTION

Currently, many information signals, in the form of modulations of laser-produced electromagnetic radiation, are transmitted over optical communications fibers (hereinafter electromagnetic radiation is referred to as “light”, regardless of wavelength). Typically, a number of optical fibers are combined into a fiber optic cable. When a fiber optic cable carries many individual signals, it is necessary sometimes to switch these signals onto other fiber within the same cable or onto other fiber optic cables.

Various switching systems capable of routing light from one direction to another are known in the art.

In one type of such systems, the laser-produced light is converted first into corresponding electrical systems. Thereafter, the electrical signals are handled by electrical circuitry and are converted into corresponding modulated light for retransmission through fibers. The conversion of the light to electrical signals and then back into modulated light by using the electrical switching circuitry requires the use of expensive components and usually does not provide the bandwidth required in modem communication systems.

Optical switch systems, capable or redirecting light without being converted it into electric systems, are also known in the art. The main technologies of such so-called “photonic switches” are based on thermo-optics, electroholographs, liquid crystals, acousto-optics, and two and three-dimensional micro-electromechanical systems (MEMS).

For example, various thermo-optic switch systems, which employ heat to activate the switching mechanism are known in the art. In such systems, optical switching between two waveguides may be accomplished by heating an interguide region between two optical waveguide cores to alter its refractive index. For example, U.S. Pat. No. 5,173,956 describes a technique in which optical switching between two waveguides with a common cladding interguide region is achieved by passing a current through the interguide region to heat it and thereby alter its refractive index. Some of the flaws of such switches include a limitation in strength of the transmitted optical flux and losses through dissipation in the interguide region.

U.S. Pat. No. 5,699,462; U.S. Pat. No. 6,160,928 and U.S. Pat. No. 6,212,308 describe various thermo-optic switches that rely on bubbles. The switch elements are located at the intersection of optical waveguides. The channel at the intersection of the waveguides is filled with fluid having an index of refraction identical to that of the waveguide. Consequently, the light beam traverses the switch without any diversion. However, by heating the fluid, a small bubble forms within the switch element, which alters the path of the light beam.

Various optic switch systems based on liquid crystals (see, for example, U.S. Pat. No. 5,440,654) may also be utilized for re-directing light emitted by one fiber onto another without the aforementioned optical-electrical-optical conversion. Usually these systems utilize a liquid crystal to rotate the beam's polarization. However, the performance of the prior art systems does not usually satisfy telecom standards. For example, when exposed to low temperature, the switch systems based on liquid crystals could cause crosstalk. Additionally, such systems are rather slow, i.e., sometimes taking miliseconds or even hundreds of miliseconds to operate.

Various optic deflection and switch devices in optic projection systems are known in the art (see, for example, U.S. Pat. No. 3,981,566; U.S. Pat. No. 4,025,203; U.S. Pat. Nos. 5,444,565; 5,481,396 and U.S. Pat. No. 6,198,565). Such devices comprise a reflective surface (mirror) for receiving and reflecting an incident optical beam and an actuator for controlling the angular position of the reflective surface.

The principles of optical beam deflection by means of reflective surfaces were also utilized in fiber optic switches.

U.S. Pat. No. 5,208,880 describes a microdynamical optical switch disposed on a silicon substrate. The switch includes a piezoelectric actuator disposed on the substrate coupled to a mirror. The mirror may be displaced along At a linear displacement path in correspondence to deflection of the piezoelectric actuator. The switch has at least one optical input connection port and a plurality of optical output connection ports. A light passing from the input connection port may be directed to a selected output connection port in dependence on the position of the mirror along the mirror displacement path.

U.S. Pat. No. 5,915,063 describes an optical attenuator that includes a flexure member, which consists of a bridge portion joining two prongs connected to an actuator. The prongs can expand or contract in response to a control signal applied to the actuator. A mirror is mounted on the bridge portion. The control signal may be heat, an electric field, a magnetic field or, preferably, a combination thereof. The attenuator is positioned opposite a pair of optical waveguides so that an input optical signal from an input waveguide is incident on the mirror and, upon reflection, received by the second waveguide. Attenuation of the transmission is effected by controlled tilting of the mirror caused by appropriate control signals applied to the actuator.

U.S. Pat. No. 6,014,477 describes a switching element comprising a photostrictive actuating element for changing the direction of the light beam from an input port to a predetermined output port in response to an optical control signal applied to the actuating element.

One of the drawbacks of the prior art switching system utilizing a reflective surface for deflection of an optical beam is associated with the limitation of the dynamic range of linear displacement of the reflective surface. For example, the use of a magnetostrictive actuator, utilizing a material having “giant” magnetostriction (e.g. ferrite-garnet Tb₃Fe₅O₁₂), may provide the maximum range of displacement of the reflective surface that hardly exceeds 10μ within the relevant range of frequencies higher than 1 MHz. Therefore, when the fibers are relatively thick and the space between the focuses of he reflected beams is insufficient to allow the placing of the output fibers with cladding. Aditionally, such systems are rather slow, i.e. sometimes taking miliseconds or even hundreds of miliseconds to operate.

Despite the prior art in the area of optical switch systems, there is still a need for further improvement to provide an optical switch system which can be produced relatively inexpensively and which will substantially increase switching speed when compared with the hitherto known techniques.

### SUMMARY OF THE INVENTION

The general purpose of the present invention, which will be described subsequently in greater detail, is to satisfy the aforementioned need by providing a novel high-speed optic switching system and method for controllably redirecting an incident optical solid conical beam emanated from a primary waveguide onto at least one secondary waveguide. The system includes at least two reflective concave surfaces, or mirrors (a primary mirror and secondary mirror), and at least one actuator. The primary mirror has a radius greater than the radius of the secondary mirror.

Since the optic switching system employs concave mirrors having reflective inner surfaces, the mirrors operate as both a focusing element and a reflector. The primary mirror receives an original incident solid conical beam emitted by the primary waveguide, reflects this beam and focuses the reflected beam at a primary focusing place with respect to the direction of light propagation. The secondary mirror is disposed at the place downstream of the primary focusing place. A location of the secondary mirror is selected according to the following condition. The distance between the secondary mirror and the focusing place along an axis of the optical beam is less than the distance between the primary mirror and the focusing place along the axis of the optical beam. As a consequence of this condition, an area covered by the solid beam (illuminated spot) on the secondary mirror is less than an area covered by the solid beam on the primary mirror.

According to one embodiment of the present invention, the actuator is operatively connected to the primary mirror. According to another embodiment of the present invention, the actuator is operatively connected to the secondary mirror.

The actuator may include at least one member, which may be made of a magnetostrictive, electrostrictive, photostrictive or thermally expansible material. The member may change its dimension or dimensions in response to the applied control signal that is an appropriate magnetic, electric, photonic field or heat, respectively (generally, an external field or effect).

The member in the actuator is disposed in such a way that a dimensional change of the member in response to the control signal results in displacement of the primary and/or secondary mirror.

Upon application of a control signal to the actuator, the actuator is operable to control selective displacement of the mirror connected thereto relative to the optical signal beam that impinges thereon. For example, if the actuator is operatively connected to the primary mirror, then the displacement of the mirror causes a change of the direction of the beam reflected from the prim mirror. Such a change in the beam direction, in turn, changes the incident angle at which the beam impinges on the secondary mirror, and, correspondingly, the angle of reflection from the secondary mirror. Thus, as a consequence of the application of the predetermined control signal to the actuator, the optical signal beam from a primary waveguide may be selectively coupled to one or more secondary waveguides.

The optic switching system of the present invention has many of the advantages of the techniques mentioned theretofore, while simultaneously overcoming some of the disadvantages normally associated therewith.

The optic switching system of the present invention can operate with minimal losses of radiation, maximum operation speed and has no limitation in strength of the light flux to be switched.

The optic switching system according to the present invention may be easily and efficiently manufactured and marketed.

The optic switching system according to the present invention is of durable and reliable construction.

The optic switching system according to the present invention may have a low manufacturing cost.

In summary, according to one broad aspect of the present invention, there is provided an optic switching system for controllably directing an incident beam of electromagnetic radiation propagating with a certain solid angle from a primary optical waveguide to a predetermined secondary optical waveguide, the system comprising:

a primary reflective concave surface disposed for receiving said incident beam, reflecting the incident beam and focusing a reflected beam at a primary focusing place;

a secondary reflective concave surface having a radius less man a radius of said primary reflective concave surface, said secondary reflective concave surface being disposed for receiving the beam reflected by said first reflective surface and reflecting this beam to said predetermined secondary optical waveguide, said secondary reflective concave surface being disposed at the place located downstream of said primary focusing place with respect to the direction of propagation of said beam reflected from the primary reflective concave surface;

at least one actuator operatively connected to at least one reflective surface of said primary concave reflective surface and said secondary concave reflective surface, said at least one actuator being adapted for controlling a selective displacement of said at least one reflective surface relative to the optical beam that impinges thereon.

According to another broad aspect of the present invention, there is provided a optic switching system for controllably directing an incident beam of electromagnetic radiation propagating with a certain solid angle from a primary optical waveguide to a selected one from a plurality of secondary optical waveguide, the system comprising:

a primary reflective concave surface disposed for receiving said incident beam, reflecting the incident beam and focusing a reflected beam at a primary focusing place;

a secondary reflective concave surface having a radius less than a radius of said primary reflective concave surface, said secondary reflective concave surface being disposed for receiving the beam reflected by said primary reflective surface and reflecting this towards the secondary optical waveguides, said secondary reflective concave surface being disposed at the place located downstream of said primary focusing place with respect to the direction of propagation of said beam reflected from the primary reflective concave surface;

at least one actuator operatively connected to at least one reflective surface of said primary concave reflective surface and said secondary concave reflective surface, said at least one actuator being adapted for controlling a selective displacement of said at least one reflective surface relative to the optical beam that impinges thereon, thereby providing the propagation of the beam reflected from the secondary reflective concave surface to said selected one of the plurality of secondary waveguides.

According to filter broad aspect of the present invention, there is provided a 1×N optical switch for controllably directing an incident beam of electromagnetic radiation propagating with a certain solid angle from a primary optical waveguide to a selected one from N secondary optical waveguides, the switch comprising:

a primary reflective concave surface disposed for receiving said incident beam, reflecting the incident beam and focusing a reflected beam at a primary focusing place;

a secondary reflective concave surface having a radius less than a radius of said primary reflective concave surface, said secondary reflective concave surface being disposed for receiving the beam reflected by said primary reflective surface and reflecting this beam towards the secondary optical waveguides, said secondary reflective concave surface being disposed at the place located downstream of said primary focusing place with respect to the direction of propagation of said beam reflected from the primary reflective concave surface;

at least one actuator operatively connected to at least one reflective surface of said primary concave reflective surface and said secondary concave reflective surface, said at least one actuator being adapted for controlling a selective displacement of said at least one reflective surface relative to the optical beam that impinges thereon, thereby providing the propagation of the beam reflected from the secondary reflective concave surface to said selected one of the N secondary waveguides.

According to still further broad aspect of the present invention, there is provided a method of controllably directing an incident beam of electromagnetic radiation propagating with a certain solid angle from a primary optical waveguide to a predetermined secondary optical waveguide, the method comprising:

impinging said incident beam onto a primary reflective concave surface disposed for receiving said incident beam, reflecting the beam and focusing the beam at a primary focussing place;

receiving the optical beam reflected from the primary reflective surface by a secondary reflective concave surface, said secondary reflective concave surface being disposed at the place located downstream of said primary focusing place with respect to the direction of propagation of said beam reflected from the primary reflective concave surface;

operating at least one actuator operatively connected to at least one reflective surface of said primary reflective concave surface and said secondary reflective concave surface for controlling a selective displacement of said at least one reflective surface relative to the optical beam that impinges thereon, thereby providing propagation of the beam reflected from the secondary reflective concave surface to the predetermined secondary waveguide.

According to yet another broad aspect of the present invention, there is provided a method of controllably directing an incident beam of electromagnetic radiation propagating with a certain solid angle from a primary optical waveguide to a selected one of a plurality of secondary optical waveguide, the method comprising:

impinging said incident beam onto a primary reflective concave surface disposed for receiving said incident beam, reflecting the beam and focusing the beam at a primary focussing place;

receiving the optical beam reflected from the primary reflective surface by a secondary reflective concave surface, said secondary reflective concave surface being disposed at the place located downstream of said primary focusing place with respect to the direction of propagation of said beam reflected from the primary reflective concave surface;

operating at least one actuator operatively connected to at least one reflective surface of said primary reflective concave surface and said secondary reflective concave surface for controlling a selective displacement of said at least one reflective surface relative to the optical beam that impinges thereon, thereby re-directing the propagation of the beam reflected from the secondary reflective concave surface to the selected one of the plurality of secondary waveguide.

There has thus been outlined, rather broadly, the more important features of the invention so that the detailed description thereof that follows hereinafter may be better understood, and the present contribution to the art may be better appreciated. Additional details and advantages of the invention will be set forth in the detailed description, and in part will be obvious from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to a sole accompanying drawing, in which:

FIG. 1 illustrates a schematic cross-sectional view of one embodiment of the optic switching system according to the present invention.

### DETAILED DESCRIPTION OF SPECIFIC EMBODIMENTS

The principles and operation of a system and a method according to the present invention may be better understood with reference to the drawing and the accompanying description.

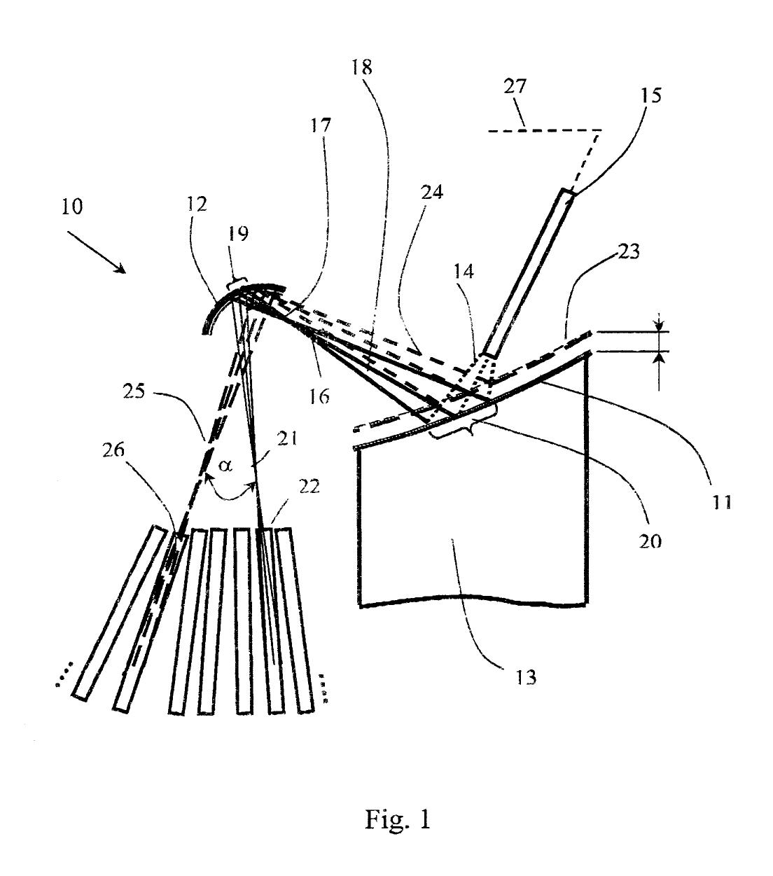

Referring to FIG. 1, an optic switching system 10 according to one embodiment of the present invention includes a primary concave mirror 11, a secondary concave mirror 12 and an actuator 13, which is operatively connected to the primary concave mirror 11. The primary and secondary mirrors 11 and 12 may be any reflective concave surfaces. The primary mirror 11 has a radius greater than that of the secondary concave mirror 12. The system 10 actually presents a 1×N switch (N=7 in the example shown in FIG. 1).

Since the optic switching system employs concave mirrors having reflective inner surfaces, the mirrors operate as both a focusing element and a reflector. If needed, the collimating of output beams may be achieved by choosing an appropriate radius for each of the two mirrors. The absence of lenses or other transparent elements in the system of the present invention is of basic importance. It is well known that the utilization of lenses as focusing elements may result in limiting the strength of transmitted fluxes, and loss due to the dissipation of energy in the lenses.

The primary mirror 11 receives an original optical solid conical beam 14 supplied from a primary waveguide 15, reflects this beam and focuses a reflected beam 16 at a primary focusing place 17. The secondary mirror 12 is disposed at the place downstream of the primary focusing place 17 with respect to the direction of beam propagation.

The location of the secondary mirror 12 is selected according to the following condition. The distance between the secondary mirror 12 and the focusing place 17 along an axis 18 of the reflected optical conical beam 16 is less than the distance between the primary mirror and the focusing place 17 along the axis 18. As a consequence of this condition, an area 19 (illuminated spot) covered by the solid beam on the secondary mirror 12 is less than an area 20 (illuminated spot) covered by the solid beam 14 on the primary mirror 11.

A secondary reflected beam 21 reflected from the secondary mirror 12 may be directed to a selected secondary waveguide 22 located in the vicinity of a secondary focusing place 28 of the beam 21. Such a configuration of the system, according to this embodiment, allows to decrease significantly the diameter of the secondary waveguide 22 that might be important for effective utilization of the space in the case of using a plurality of secondary waveguides located close to each other.

The actuator 13 includes one or more members (only one being shown in the present example) made of a magnetostrictive, electrostrictive, photostrictive or thermally expansible material. The member is of the kind characterized in that its dimension or dimensions can be changed in response to the applied control signal that is an appropriate heat, magnetic, electric, photonic or other external field. The member in the actuator is disposed in such a way that a dimensional change of the member in response to a control signal results in displacement of the primary mirror 11 along the longitudinal axis of the member 13. 75 Upon application of the control signal to the actuator 13, the actuator 13 is operable to control selective displacement of the mirror 11 connected thereto, relative to the optical signal beam 14 that impinges thereon. The displacement of the mirror 11 to a new position 23 (shown in dashed lines) causes a change in the direction of the beam 24 reflected from the primary mirror. Such deflections of the beam, in turn, changes the incident angle at which the beam 24 impinges onto the secondary mirror 12, and, correspondingly, the angle of reflection of a beam 25 reflected from the secondary mirror 12. Thus, as a consequence of the application of the predetermined control signal to the actuator 13, the original optical beam 14 from a primary waveguide 15 may be selectively re-directed from the secondary waveguide 22 to a secondary waveguide 26.

It should be appreciated that the primary optical waveguide 15 and the secondary optical waveguides 22 and 26, for example, may be optic fibers.

The following non-limiting example is provided for the purpose of illustration of operation of the above-described switch system.

The incident solid conical beam 14 (supplied from a waveguide 15 having a cross section with the diameter of 10μ (microns)) has the solid angle of 18° and is tilted by 70° with respect to a horizontal reference line 27. The beam 14 is directed onto the prim mirror 11 having the radius of 500μ. The beam 16 reflected from the mirror 11 is directed onto the secondary mirror 12 having the radius of 30μ and located at die distance of 200μ along the axis 18. The beam 21 reflected from the secondary mirror 12 is directed to the selected secondary waveguide 22 located in the vicinity of the secondary focusing place 28.

According to computer simulation, upon a displacement of the primary mirror 11, for instance, in the upward direction on the value of 5μ, the angle α between the beams 21 and 25 reflected from the secondary mirror before and after the displacement, respectively, has a value of 20°.

In the present example, the switch system 10 of the present invention includes the actuator 13 having the member in the form of a rod made of a magnetostrictive material and a mirror which is attached to an end of the rod. If the material has a “giant” magnetostriction (e.g., ferrite-garnet Tb₃Fe₅O₁₂ capable to change its relative length on the value of 0.25% within the range of frequencies of the order of 1 MHz), then a relatively large displacement value of 25μ may be attained for the mirror attached to the rod having the linear size of 10 mm.

Thus, utilizing the described optical configuration and the actuator made of the materials having such magnetostrictive properties allows us to manufacture a high-speed optic system capable to utilize a relatively large number of the secondary waveguides and to provide deflection of the beam on rather large angles over a short time period.

As such, those skilled in the art to which the present invention pertains, can appreciate that while the present invention has been described in terms of preferred embodiments, the conception, upon which this disclosure is based, may readily be utilized as a basis for the designing of other structures systems and processes for carrying out the several purposes of the present invention.

It is apparent that the actuator 13 may be operatively connected with the secondary concave mirror 12.

It is readily appreciated that the actuator 13 may be operable to cause displacements of the concave mirrors 11 and/or 12 to move in all directions that includes up and down, forward and backward, left to right and a reverse movement. The actuator 13 may also be operable to cause a tilting movement of the mirror(s).

Also, it is to be understood that the phraseology and terminology employed herein are for the purpose of description and should not be regarded as limiting.

In the method claims that follow, alphabetic characters used to designate claim steps are provided for convenience only and do not imply any particular order of performing the steps.

It is important, therefore, that the scope of the invention is not construed as being limited by the illustrative embodiments set forth herein. Other variations are possible within the scope of the present invention as defined in the appended claims and their equivalents.

1. An optic switching system for controllably directing an incident beam of electromagnetic radiation propagating with a certain solid angle from a primary optical waveguide to a predetermined secondary optical waveguide, the system comprising:
(a) a primary reflective concave surface disposed for receiving said incident beam, reflecting the incident beam and focusing a reflected beam at a primary focusing place;
(b) a secondary reflective concave surface having a radius less than a radius of said primary reflective concave surface, said secondary reflective concave surface being disposed for receiving the beam reflected by said first reflective surface and reflecting this beam to said predetermined secondary optical waveguide, said secondary reflective concave surface being disposed at the place located downstream of said primary focusing place with respect to the direction of propagation of said beam reflected from the primary reflective concave surface;
(c) at least one actuator operatively connected to at least one reflective surface of said primary concave reflective surface and said secondary concave reflective surface, said at least one actuator being adapted for controlling a selective displacement of said at least one reflective surface relative to the optical beam that impinges thereon.

2. The system of claim 1, wherein an illuminated area on said secondary reflective concave surface is smaller than an illuminated area on said primary reflective concave surface.

3. The system of claim 1, wherein the distance between said secondary reflective concave surface and the focusing place along an axis of the optical beam is less than the distance between said primary reflective concave surface and the focusing point along said axis of the optical beam.

4. The system of claim 1, wherein said at least one secondary optical waveguide is disposed at the place located downstream of the secondary focusing place.

5. The system of claim 4, wherein the distance between said secondary reflective concave surface and said secondary optical waveguide is selected to comply with a condition of matching between the optical solid conical beam reflected by said secondary reflective concave surface and the aperture area defined by said secondary optical waveguide.

6. The system of claim 1, wherein said primary optical waveguide and said secondary optical waveguide are optic fibers.

7. The system of claim 1, wherein said at least one actuator is operable to cause a translational displacement of said at least one reflective surface.

8. The system of claim 1, wherein said at least one actuator comprises at least one member capable of changing its dimension in response to a control signal applied thereto.

9. The system of claim 8, wherein said control signal is an external field selected from a group consisting of magnetic field, electric field, photonic field and heat.

10. The system of claim 8, wherein the displacement of said at least one reflective surface is caused by a dimensional change of said at least one member.

11. The system of claim 8, wherein said at least one member is made of a magnetostrictive material.

12. The system of claim 8, wherein said at least one member is made of an elctrostrictive material.

13. The system of claim 8, wherein said at least one member is made of a photostrictive material.

14. The system of claim 8, wherein said at least one member is made of a thermally expansible material.

15. An optic switching system for controllably directing an incident beam of electromagnetic radiation propagating with a certain solid angle from a primary optical waveguide to a selected one from a plurality of secondary optical waveguide, the system comprising:
(a) a primary reflective concave surface disposed for receiving said incident beam, reflecting the incident beam and focusing a reflected beam at a primary focusing place;
(b) a secondary reflective concave surface having a radius less than a radius of said primary reflective concave surface, said secondary reflective concave surface being disposed for receiving the beam reflected by said primary reflective surface and reflecting this beam towards the secondary optical waveguides, said secondary reflective concave surface being disposed at the place located downstream of said primary focusing place with respect to the direction of propagation of said beam reflected from the primary reflective concave surface;
(c) at least one actuator operatively connected to at least one reflective surface of said primary concave reflective surface and said secondary concave reflective surface, said at least one actuator being adapted for controlling a selective displacement of said at least one reflective surface relative to the optical beam that impinges thereon, thereby providing the propagation of the beam reflected from the secondary reflective concave surface to said selected one of the plurality of secondary waveguides.

16. A 1×N optical switch for controllably directing an incident beam of electromagnetic radiation propagating with a certain solid angle from a primary optical waveguide to a selected one from N secondary optical waveguides, the switch comprising:
(a) a primary reflective concave surface disposed for receiving said incident beam, reflecting the incident beam and focusing a reflected beam at a primary focusing place;
(b) a secondary reflective concave surface having a radius less than a radius of said primary reflective concave surface, said secondary reflective concave surface being disposed for receiving the beam reflected by said primary reflective surface and reflecting this beam towards the secondary optical waveguides, said secondary reflective concave surface being disposed at the place located downstream of said primary focusing place with respect to the direction of propagation of said beam reflected from the primary reflective concave surface;
(c) at least one actuator operatively connected to at least one reflective surface of said primary concave reflective surface and said secondary concave reflective surface, said at least one actuator being adapted for controlling a selective displacement of said at least one reflective surface relative to the optical beam that impinges thereon, thereby providing the propagation of the beam reflected from the secondary reflective concave surface to said selected one of the N secondary waveguides.

17. A method of controllably directing an incident beam of electromagnetic radiation propagating with a certain solid angle from a primary optical waveguide to a predetermined secondary optical waveguide, the method comprising:
(i) impinging said incident beam onto a primary reflective concave surface disposed for receiving said incident beam, reflecting the beam and focusing the beam at a primary focussing place;
(ii) receiving the optical beam reflected from the primary reflective surface by a secondary reflective concave surface, said secondary reflective concave surface being disposed at the place located downstream of said primary focusing place with respect to the direction of propagation of said beam reflected from the primary reflective concave surface;
(iii) operating at least one actuator operatively connected to at least one reflective surface of said primary reflective concave surface and said secondary reflective concave surface for controlling a selective displacement of said at least one reflective surface relative to the optical beam that impinges thereon, thereby providing propagation of the beam reflected from the secondary reflective concave surface to the predetermined secondary waveguide.

18. A method of controllably directing an incident beam of electromagnetic radiation propagating with a certain solid angle from a primary optical waveguide to a selected one of a plurality of secondary optical waveguide, the method comprising:
(i) impinging said incident beam onto a primary reflective concave surface disposed for receiving said incident beam., reflecting the beam and focusing the beam at a primary focussing place;
(ii) receiving the optical beam reflected from the primary reflective surface by a secondary reflective concave surface, said secondary reflective concave surface being disposed at the place located downstream of said primary focusing place with respect to the direction of propagation of said beam reflected from the primary reflective concave surface;
(iii) operating at least one actuator operatively connected to at least one reflective surface of said primary reflective concave surface and said secondary reflective concave surface for controlling a selective displacement of said at least one reflective surface relative to the optical beam that impinges thereon, thereby re-directing the propagation of the beam reflected from the secondary reflective concave surface to the selected one of the plurality of secondary waveguide.

19. The method of claim 17, wherein an illuminated area on said secondary reflective concave surface is smaller than an illuminated area on said primary reflective concave surface.

20. The method of claim 17, wherein the distance between said secondary reflective concave surface and the focusing place along an axis of the optical beam is less than the distance between said primary reflective concave surface and the focusing point along said axis of the optical beam.

21. The method of claim 17, wherein said at least one secondary optical waveguide is disposed at the place located downstream of the secondary focusing place.

22. The method of clam 21, wherein the distance between said secondary reflective concave surface and said secondary optical waveguide is selected to comply with a condition of matching between the optical solid conical beam reflected by said secondary reflective concave surface and the aperture area defined by said secondary optical waveguide.

23. The method of claim 17, said primary optical waveguide and said secondary optical waveguide are optic fibers.

24. The method of claim 17, wherein said at least one actuator is operable to cause a translational displacement of said at least one reflective surface.

25. The method of claim 17, wherein said at least one actuator comprises at least one member capable of changing its dimension in response to a control signal applied thereto.

26. The method of claim 25, wherein said control signal is an external field selected from a group consisting of magnetic field, electric field, photonic field and heat.

27. The method of claim 25, wherein the displacement of said at least one reflective surface is caused by a dimensional change of said at least one member.

28. The method of claim 25, wherein said at least one member is made of a magnetostrictive material.

29. Thc method of claim 25, wherein said at least one member is made of an elctrostrictive material.

30. The method of claim 25, wherein said at least one member is made of a photostrictive material.

31. The method of claim 25, wherein said at least one member is made of a thermally expansible material.
